(19) United States
(12) Patent Application Publication
(10) Pub. No.: US 2020/0156108 A1
(43) Pub. Date: May 21, 2020

(54) THREE-LEVEL VOLTAGE BURST GENERATION SUITABLE FOR ULTRASONIC IMAGING APPLICATION

(71) Applicant: QUALCOMM Incorporated, San Diego, CA (US)

(72) Inventors: Shitong Zhao, San Diego, CA (US); Masoud Roham, San Diego, CA (US); Lennart Mathe, San Diego, CA (US); Bo-Ren Wang, San Diego, CA (US)

(21) Appl. No.: 16/194,181

(22) Filed: Nov. 16, 2018

(51) Int. Cl. B06B 1/02; B06B 1/06; G01S 15/89; G01S 7/52

(52) U.S. Cl. CPC B06B 1/0215; B06B 1/0607; G06K 9/0002; G01S 7/5202; B06B 2201/55; G01S 15/89

(57) ABSTRACT

A voltage burst is generated using a voltage supply having a single DC output voltage, V_{H} coupled with a switching arrangement, including an input and a voltage transmitter output (Tx_Out), the input coupled with the output of the voltage supply. A control arrangement coupled with the switching arrangement is configured to operate the switching arrangement so as to provide, at the Tx_Out, a voltage burst that varies between an intermediate voltage, V_{M}, and one or both of V_{H}, and a minimum voltage, V_{L}, where V_{L}<V_{M}<V_{H}.

### TECHNICAL FIELD

This disclosure relates to generating a three-level voltage output from a voltage supply having a single nominal output voltage, more particularly, in some implementations a three-level voltage burst is generated for ultrasonic imaging applications.

### DESCRIPTION OF THE RELATED TECHNOLOGY

Ultrasonic sensor systems may use a transmitter to generate and send an ultrasonic wave through a transmissive medium and towards an object to be detected and/or imaged. The ultrasonic transmitter may be operatively coupled with an ultrasonic sensor array configured to detect portions of the ultrasonic wave that are reflected from the object. At each material interface encountered by the ultrasonic pulse, a portion of the ultrasonic pulse may be reflected. An ultrasonic sensor system may include biometric sensors, such as fingerprint or handprint sensors, and/or other ultrasonic imaging applications.

Piezoelectric ultrasonic transducers are attractive candidates for such applications and may include piezoelectric micromechanical ultrasonic transducers (PMUTs) configured as a multilayer stack that includes a piezoelectric layer stack. The piezoelectric layer stack may include a layer of piezoelectric material such as, for example, a layer of polyvinylidene fluoride (PVDF) or a PVDF copolymer. The piezoelectric layer may convert vibrations caused by ultrasonic reflections into electrical output signals. In some implementations, the ultrasonic sensor system further includes a thin-film transistor (TFT) layer that may include an array of sensor pixel circuits that may, for example, amplify electrical output signals generated by the piezoelectric layer.

Transmitter excitation signals may be coupled to one or more electrodes in each PMUT or PMUT array, such as a transmit electrode associated with each PMUT, to allow the generation and launching of ultrasonic waves.

The transmitter excitation signals are conventionally provided in a cyclic burst having a cyclically varying voltage. Generally, at start of the burst, the voltage is a minimum or low voltage, V_{L}, for example, zero or a ground voltage, and the voltage cyclically varies, during a duration of the burst, between V_{L} and a maximum or high voltage, V_{H}, returning, at the end of the burst, to V_{L}. The voltage V_{H} may be provided to a switching arrangement by a DC power supply having a single high voltage output equal to V_{H}.

For certain uses, including ultrasonic sensing as described above, a signal waveform is desirable in which a selectable third voltage, intermediate between V_{L} and V_{H}, may be provided to the electrodes notwithstanding that the DC power supply has only a single output voltage equal to V_{H}.

### SUMMARY

The systems, methods and devices of this disclosure each have several innovative aspects, no single one of which is solely responsible for the desirable attributes disclosed herein.

One innovative aspect of the subject matter described in this disclosure relates to an apparatus for generating a voltage burst. The apparatus includes a voltage supply having a single DC output voltage, V_{H}, an a switching arrangement, including an input and a voltage transmitter output (Tx_Out), the input coupled with the output of the voltage supply, and a control arrangement coupled with the switching arrangement and configured to operate the switching arrangement so as to provide, at the Tx_Out, a voltage burst that varies between an intermediate voltage, V_{M}, and one or both of V_{H}, and a minimum voltage, V_{L}. V_{L} is less than V_{M} which is less than V_{H}.

In some examples, V_{L} may be zero.

In some examples, V_{M} may be an average of V_{L} and V_{H}.

In some examples, the switching arrangement may include a pMOSFET and an nMOSFET, coupled with a clock. In some examples, the input of the switching arrangement may be electrically coupled with a source terminal of the pMOSFET; a source terminal of the nMOSFET may be coupled with ground; and the Tx_Out may be coupled, by way of a respective drain terminal, with each of the pMOSFET and the nMOSFET.

In some examples, the control arrangement may include a bit-wise delay line register, a successive approximation module and a comparator circuit. In some examples, the control arrangement may be configured to execute a plurality of successive approximation cycles, and, after each of the successive cycles, make a comparison between a measured voltage value at the Tx_Out and a target value of the intermediate voltage V_{M}. In some examples, the bit-wise delay line register may include a plurality of delay units; and, based on the comparison after each of the successive cycles, a respective one of the plurality of delay units may be enabled or disabled by the control arrangement. In some examples, V_{M} may be adjustable, by the control arrangement, within a range between V_{L} and V_{H}.

In some examples, the Tx_Out may be electrically coupled with a Tx driver configured to excite an ultrasonic transmitter and produce one or more ultrasonic waves. In some examples, V_{H} is in the range of 20-40 volts and V_{M} is in the range of 8-22 volts.

According to some implementations, a method for generating a voltage burst includes operating a switching arrangement with a control arrangement coupled with the switching arrangement so as to provide, at a voltage transmitter output (Tx_Out) of the switching arrangement, a voltage burst that varies between an intermediate voltage, V_{M}, and one or both of V_{H}, and a minimum voltage, V_{L}. The switching arrangement includes an input coupled to an output of a voltage supply having a single DC output voltage, V_{H}, and V_{L} is less than V_{M} which is less than V_{H}.

In some examples, V_{L} may be zero.

Some examples, V_{M} may be an average of V_{L} and V_{H}.

In some examples, the switching arrangement may include a pMOSFET and an nMOSFET, coupled with a clock.

In some examples, the control arrangement may include a bit-wise delay line register, a successive approximation module and a comparator circuit. In some examples, operating the switching arrangement may include executing a plurality of successive approximation cycles; and after each of the successive cycles, making a comparison between measured voltage value at the Tx_Out and a target value of the intermediate voltage V_{M}. In some examples, the bit-wise delay line register may include a plurality of delay units and operating the switching arrangement may include enabling or disabling a respective one of the plurality of delay units with the control arrangement based on the comparison after each of the successive cycles. In some examples, V_{M} may be adjustable, by the control arrangement, within a range between V_{L} and V_{H}.

In some examples, the Tx_Out may be electrically coupled with a Tx driver of an ultrasonic transducer and further comprising exciting an ultrasonic transmitter and produce one or more ultrasonic waves.

According to some implementations in a non-transitory computer readable medium having software stored thereon, the software includes instructions for causing an apparatus to generate a voltage burst. The instructions include: operating a switching arrangement with a control arrangement coupled with the switching arrangement so as to provide, at a voltage transmitter output (Tx_Out) of the switching arrangement, a voltage burst that varies between an intermediate voltage, V_{M}, and one or both of V_{H}, and a minimum voltage, V_{L}. The switching arrangement includes an input coupled to an output of a voltage supply having a single DC output voltage, V_{H}; and V_{L} is less than V_{M} which is less than V_{H}.

In some examples, the control arrangement may include a bit-wise delay line register, a successive approximation module and a comparator circuit. In some examples, operating the switching arrangement may include executing a plurality of successive approximation cycles, and, after each of the successive cycles, making a comparison between measured voltage value at the Tx_Out and a target value of the intermediate voltage V_{M}. In some examples, the bit-wise delay line register may include a plurality of delay units and operating the switching arrangement may include enabling or disabling a respective one of the plurality of delay units with the control arrangement based on the comparison after each of the successive cycles.

In some examples, the Tx_Out may be electrically coupled with a Tx driver of an ultrasonic transducer and further comprising exciting an ultrasonic transmitter and produce one or more ultrasonic waves.

According to some implementations, an apparatus for generating a voltage burst includes an ultrasonic transducer, a voltage supply having a single DC output voltage, V_{H}, a switching arrangement, including an input and a voltage transmitter output (Tx_Out), Tx_Out being electrically coupled with a Tx driver configured to excite the ultrasonic transmitter, the input being coupled the output of the voltage supply, and a control arrangement coupled with the switching arrangement and configured to operate the switching arrangement so as to provide, at the Tx_Out, a voltage burst that varies between an intermediate voltage, V_{M}, and one or both of V_{H}, and a minimum voltage, V_{L}, where V_{L} is less than V_{M} which is less than V_{H}. In some examples, the switching arrangement includes a pMOSFET and an nMOSFET, may be coupled with a clock, the input of the switching arrangement may be electrically coupled with a source terminal of the pMOSFET, a source terminal of the nMOSFET may be coupled with ground, and the Tx_Out may be coupled, by way of a respective drain terminal, with each of the pMOSFET and the nMOSFET.

In some examples, the control arrangement may include a bit-wise delay line register, a successive approximation module and a comparator circuit. In some examples, the control arrangement may be configured to: execute a plurality of successive approximation cycles, and, after each of the successive cycles, make a comparison between a measured voltage value at the Tx_Out and a target value of the intermediate voltage V_{M}. In some examples, the bit-wise delay line register may include a plurality of delay units, and, based on the comparison after each of the successive cycles, a respective one of the plurality of delay units may be enabled or disabled by the control arrangement.

### BRIEF DESCRIPTION OF THE DRAWINGS

Details of one or more implementations of the subject matter described in this specification are set forth in this disclosure and the accompanying drawings. Other features, aspects, and advantages will become apparent from a review of the disclosure. Note that the relative dimensions of the drawings and other diagrams of this disclosure may not be drawn to scale. The sizes, thicknesses, arrangements, materials, etc., shown and described in this disclosure are made only by way of example and should not be construed as limiting. Like reference numbers and designations in the various drawings indicate like elements.

FIG. 1 shows a front view of a diagrammatic representation of an example of an electronic device that includes an ultrasonic sensing system according to some implementations.

FIG. 2A shows a block diagram representation of components of an example of an ultrasonic sensing system, according to some implementations.

FIG. 2B shows a block diagram representation of components of an example of an electronic device, according to some implementations.

FIG. 3A shows a cross-sectional of an example of an ultrasonic sensing system, according to some implementations.

FIG. 3B shows an enlarged cross-sectional side view of the ultrasonic sensing system of FIG. 3A, according to some implementations.

FIG. 4 shows an exploded projection view of an example of components of an example ultrasonic sensing system according to another implementation.

FIG. 5 illustrates a block diagram of an ultrasonic sensor system, according to an implementation.

FIGS. 6A and 6B illustrate aspects of a bi-level switching arrangement for controlling a voltage waveform provided to a Tx driver.

FIG. 7 illustrates a technique for controlling a voltage waveform, so as to obtain a tri-level voltage output, according to an implementation.

FIG. 8 illustrates a process for obtaining a desired V_{M} using successive approximation calibration, according to an implementation.

FIG. 9 illustrates a technique for controlling a voltage waveform, so as to obtain a tri-level voltage output, according to another implementation.

FIG. 10 illustrates a simulated finger print image obtained by an ultrasonic sensor using a bi-level voltage output compared with an image obtained by an ultrasonic sensor using a tri-level voltage output.

FIG. 11 illustrates an example of a process flow for generating a voltage burst, according to an implementation.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a sensor system. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands and patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, steering wheels, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, automated teller machines (ATMs), parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, ultrasonic sensor systems include piezoelectric material for the transmission and receiving of ultrasonic waves.

For example, a voltage applied across piezoelectric material corresponding to a transmitter may result in the piezoelectric material stretching or contracting, e.g., being deformed such that the material is strained in response to the applied voltage, resulting in the generation of the ultrasonic wave, as previously discussed. The reflected signals (e.g., the reflected portions of the ultrasonic wave, as previously discussed) may result in the stretching or contracting of piezoelectric material corresponding to a receiver. This results in the generation of a surface charge, and therefore, a voltage across the piezoelectric material that may be used as an electrical output signal representing a portion of raw image data that represents fingerprint image data.

Some implementations of the subject matter described in this disclosure provide circuitry for an ultrasonic sensing system. Features of related ultrasonic sensing techniques are described in U.S. patent application Ser. No. 15/292,057, filed Oct. 12, 2016, owned by the assignee of the present disclosure and entitled “INTEGRATED PIEZOELECTRIC MICROMECHANICAL ULTRASONIC TRANSDUCER PIXEL AND ARRAY”, and in U.S. patent application Ser. No. 15/704,337, filed Sep. 14, 2017 owned by the assignee of the present disclosure and entitled “ULTRASONIC TRANSDUCER PIXEL READOUT CIRCUITRY AND METHODS FOR ULTRASONIC PHASE IMAGING”, the disclosures of which are hereby incorporated by reference in their entirety into the present application.

Some implementations of the subject matter described in this disclosure may be practiced to realize one or more of the following potential advantages. Improved techniques for generating a voltage burst include a switching arrangement coupled to an output of a DC power supply having only a single high voltage output equal to V_{H}. A control arrangement operates the switching arrangement so as to cause the switching arrangement to output a selectable third voltage, less than V_{H}, and greater than zero. In some implementations, accuracy and repeatability of providing the third voltage is improved by implementing successive approximation techniques. The resulting voltage burst may be suitable for driving an ultrasonic transducer. Ultrasonic imaging using transducers driven by the disclosed using the disclosed techniques has been found to provide improved ultrasonic imaging quality.

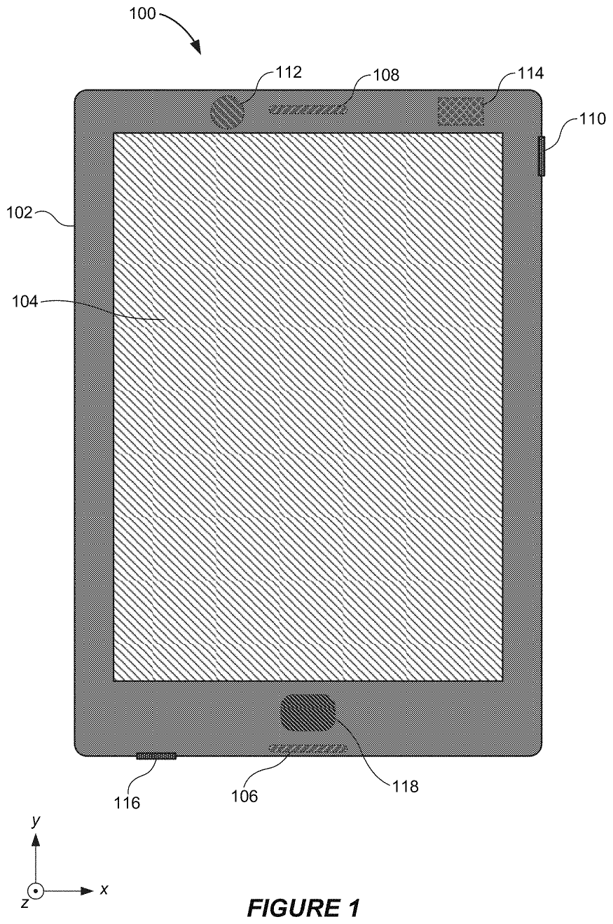

FIG. 1 shows a front view of a diagrammatic representation of an example of an electronic device 100 that includes an ultrasonic sensing system according to some implementations. The electronic device 100 may be representative of, for example, various portable computing devices such as cellular phones, smartphones, multimedia devices, personal gaming devices, tablet computers and laptop computers, among other types of portable computing devices. However, various implementations described herein are not limited in application to portable computing devices. Indeed, various techniques and principles disclosed herein may be applied in traditionally non-portable devices and systems, such as in computer monitors, television displays, kiosks, vehicle navigation devices and audio systems, among other applications. Additionally, various implementations described herein are not limited in application to devices that include displays.

In the illustrated implementation, the electronic device 100 includes a housing (or “case”) 102 within which various circuits, sensors and other electrical components may be disposed. In the illustrated implementation, the electronic device 100 also includes a display (that may be referred to herein as a “touchscreen display” or a “touch-sensitive display”) 104. The display 104 may generally be representative of any of a variety of suitable display types that employ any of a variety of suitable display technologies. For example, the display 104 may be a digital micro-shutter (DMS)-based display, a light-emitting diode (LED) display, an organic LED (OLED) display, a liquid crystal display (LCD), an LCD display that uses LEDs as backlights, a plasma display, an interferometric modulator (IMOD)-based display, or another type of display suitable for use in conjunction with touch-sensitive user interface (UI) systems.

The electronic device 100 may include various other devices or components for interacting with, or otherwise communicating information to or receiving information from, a user. For example, the electronic device 100 may include one or more microphones 106, one or more speakers 108, and in some cases one or more at least partially mechanical buttons 110. The electronic device 100 may include various other components enabling additional features such as, for example, one or more video or still-image cameras 112, one or more wireless network interfaces 114 (for example, Bluetooth, WiFi or cellular) and one or more non-wireless interfaces 116 (for example, a universal serial bus (USB) interface or an HDMI interface).

The electronic device 100 may include an ultrasonic sensing system 118 capable of imaging an object signature, such as a fingerprint, palm print or handprint. In some implementations, the ultrasonic sensing system 118 may function as a touch-sensitive control button. In some implementations, a touch-sensitive control button may be implemented with a mechanical or electrical pressure-sensitive system that is positioned under or otherwise integrated with the ultrasonic sensing system 118. In other words, in some implementations, a region occupied by the ultrasonic sensing system 118 may function both as a user input button to control the electronic device 100 as well as a sensor to enable security features such as user authentication based on, for example, a fingerprint, palm print or handprint.

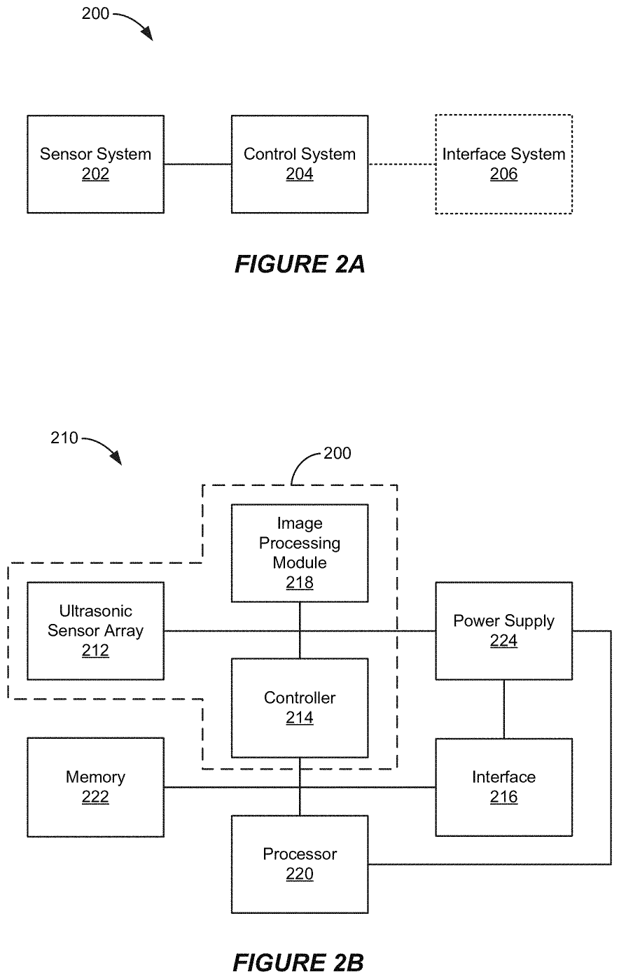

FIG. 2A shows a block diagram representation of components of an example of an ultrasonic sensing system, according to some implementations. In the illustrated implementation, an ultrasonic sensing system 200 includes a sensor system 202 and a control system 204 electrically coupled with the sensor system 202. The sensor system 202 may be capable of scanning a target object and providing raw measured image data usable to obtain an object signature of, for example, a human appendage, such as one or more fingers or toes, a palm, hand or foot. The control system 204 may be capable of controlling the sensor system 202 and processing the raw measured image data received from the sensor system 202. In some implementations, the ultrasonic sensing system 200 may include an interface system 206 capable of transmitting or receiving data, such as raw or processed measured image data, to or from various components within or integrated with the ultrasonic sensing system 200 or, in some implementations, to or from various components, devices or other systems external to the ultrasonic sensing system 200.

FIG. 2B shows a block diagram representation of components of an example of an electronic device, according to some implementations. In the illustrated example, an electronic device 210 includes the ultrasonic sensing system 200 of FIG. 2A. For example, the electronic device 210 may be a block diagram representation of the electronic device 100 shown in and described with reference to FIG. 1 above. The sensor system 202 of the ultrasonic sensing system 200 of the electronic device 210 may be implemented with an ultrasonic sensor array 212. The control system 204 of the ultrasonic sensing system 200 may be implemented with a controller 214 that is electrically coupled with the ultrasonic sensor array 212. While the controller 214 is shown and described as a single component, in some implementations, the controller 214 may collectively refer to two or more distinct control units or processing units in electrical communication with one another. In some implementations, the controller 214 may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

The ultrasonic sensing system 200 of FIG. 2B may include an image processing module 218. In some implementations, raw measured image data provided by the ultrasonic sensor array 212 may be sent, transmitted, communicated or otherwise provided to the image processing module 218. The image processing module 218 may include any suitable combination of hardware, firmware and software configured, adapted or otherwise operable to process the image data provided by the ultrasonic sensor array 212. In some implementations, the image processing module 218 may include signal or image processing circuits or circuit components including, for example, amplifiers (such as instrumentation amplifiers or buffer amplifiers), analog or digital mixers or multipliers, switches, analog-to-digital converters (ADCs), passive or active analog filters, among others. In some implementations, one or more of such circuits or circuit components may be integrated within the controller 214, for example, where the controller 214 is implemented as a system-on-chip (SoC) or system-in-package (SIP). In some implementations, one or more of such circuits or circuit components may be integrated within a DSP included within or coupled with the controller 214. In some implementations, the image processing module 218 may be implemented at least partially via software. For example, one or more functions of, or operations performed by, one or more of the circuits or circuit components just described may instead be performed by one or more software modules executing, for example, in a processing unit of the controller 214 (such as in a general purpose processor or a DSP).

In some implementations, in addition to the ultrasonic sensing system 200, the electronic device 210 may include a separate processor 220, a memory 222, an interface 216 and a power supply 224. In some implementations, the controller 214 of the ultrasonic sensing system 200 may control the ultrasonic sensor array 212 and the image processing module 218, and the processor 220 of the electronic device 210 may control other components of the electronic device 210. In some implementations, the processor 220 communicates data to the controller 214 including, for example, instructions or commands. In some such implementations, the controller 214 may communicate data to the processor 220 including, for example, raw or processed image data. It should also be understood that, in some other implementations, the functionality of the controller 214 may be implemented entirely, or at least partially, by the processor 220. In some such implementations, a separate controller 214 for the ultrasonic sensing system 200 may not be required because the functions of the controller 214 may be performed by the processor 220 of the electronic device 210.

Depending on the implementation, one or both of the controller 214 and processor 220 may store data in the memory 222. For example, the data stored in the memory 222 may include raw measured image data, filtered or otherwise processed image data, estimated PSF or estimated image data, and final refined PSF or final refined image data. The memory 222 may store processor-executable code or other executable computer-readable instructions capable of execution by one or both of the controller 214 and the processor 220 to perform various operations (or to cause other components such as the ultrasonic sensor array 212, the image processing module 218, or other modules to perform operations), including any of the calculations, computations, estimations or other determinations described herein (including those presented in any of the equations below). It should also be understood that the memory 222 may collectively refer to one or more memory devices (or “components”). For example, depending on the implementation, the controller 214 may have access to and store data in a different memory device than the processor 220. In some implementations, one or more of the memory components may be implemented as a NOR- or NAND-based Flash memory array. In some other implementations, one or more of the memory components may be implemented as a different type of non-volatile memory. Additionally, in some implementations, one or more of the memory components may include a volatile memory array such as, for example, a type of RAM.

In some implementations, the controller 214 or the processor 220 may communicate data stored in the memory 222 or data received directly from the image processing module 218 through an interface 216. For example, such communicated data can include image data or data derived or otherwise determined from image data. The interface 216 may collectively refer to one or more interfaces of one or more various types. In some implementations, the interface 216 may include a memory interface for receiving data from or storing data to an external memory such as a removable memory device. Additionally or alternatively, the interface 216 may include one or more wireless network interfaces or one or more wired network interfaces enabling the transfer of raw or processed data to, as well as the reception of data from, an external computing device, system or server.

A power supply 224 may provide power to some or all of the components in the electronic device 210. The power supply 224 may include one or more of a variety of energy storage devices. For example, the power supply 224 may include a rechargeable battery, such as a nickel-cadmium battery or a lithium-ion battery. Additionally or alternatively, the power supply 224 may include one or more supercapacitors. In some implementations, the power supply 224 may be chargeable (or “rechargeable”) using power accessed from, for example, a wall socket (or “outlet”) or a photovoltaic device (or “solar cell” or “solar cell array”) integrated with the electronic device 210. Additionally or alternatively, the power supply 224 may be wirelessly chargeable.

As used hereinafter, the term “processing unit” refers to any combination of one or more of a controller of an ultrasonic system (for example, the controller 214), an image processing module (for example, the image processing module 218), or a separate processor of a device that includes the ultrasonic system (for example, the processor 220). In other words, operations that are described below as being performed by or using a processing unit may be performed by one or more of a controller of the ultrasonic system, an image processing module, or a separate processor of a device that includes the ultrasonic sensing system.

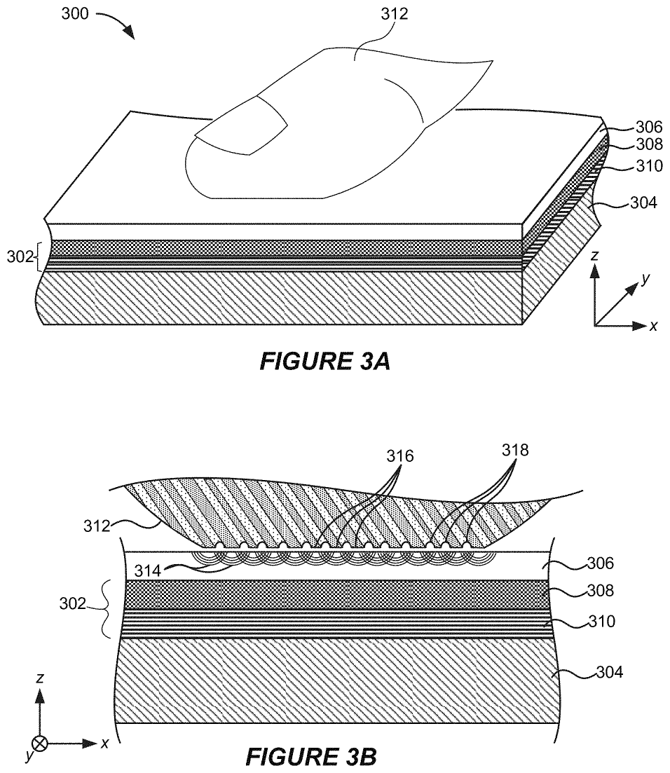

FIG. 3A shows a cross-sectional of an example of an ultrasonic sensing system according to some implementations. FIG. 3B shows an enlarged cross-sectional side view of the ultrasonic sensing system of FIG. 3A according to some implementations. In the illustrated example, the ultrasonic sensing system 300 may implement the ultrasonic sensing system 118 described with reference to FIG. 1 or the ultrasonic sensing system 200 shown and described with reference to FIGS. 2A and 2B. The ultrasonic sensing system 300 may include an ultrasonic transducer 302 that overlies a substrate 304 and that underlies a platen (a “cover plate” or “cover glass”) 306. The ultrasonic transducer 302 may include both an ultrasonic transmitter 308 and an ultrasonic receiver 310.

The ultrasonic transmitter 308 may be configured to generate ultrasonic waves towards the platen 306, and a target object 312 positioned on the upper surface of the platen 306. In the illustrated implementation the object 312 is depicted as finger, but any appendage or body part may be contemplated by the present techniques, as well as any other natural or artificial object. In some implementations, the ultrasonic transmitter 308 may more specifically be configured to generate ultrasonic plane waves towards the platen 306. In some implementations, the ultrasonic transmitter 308 includes a layer of piezoelectric material such as, for example, polyvinylidene fluoride (PVDF) or a PVDF copolymer such as PVDF-TrFE. For example, the piezoelectric material of the ultrasonic transmitter 308 may be configured to convert electrical signals provided by the controller of the ultrasonic sensing system into a continuous or pulsed sequence of ultrasonic plane waves at a scanning frequency. In some implementations, the ultrasonic transmitter 308 may additionally or alternatively include capacitive ultrasonic devices.

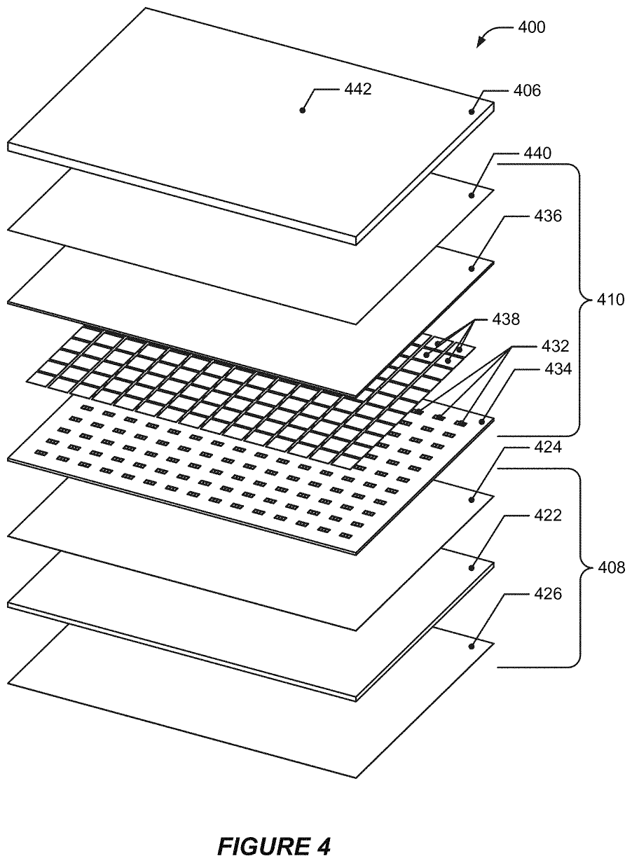

The ultrasonic receiver 310 may be configured to detect ultrasonic reflections 314 resulting from interactions of the ultrasonic waves transmitted by the ultrasonic transmitter 308 with ridges 316 and valleys 318 defining surface texture of the target object 312 being scanned. In some implementations, the ultrasonic transmitter 308 overlies the ultrasonic receiver 310 as, for example, illustrated in FIGS. 3A and 3B. In some other implementations, the ultrasonic receiver 310 may overlie the ultrasonic transmitter 308 (as shown in FIG. 4 described below). The ultrasonic receiver 310 may be configured to generate and output electrical output signals corresponding to the detected ultrasonic reflections. In some implementations, the ultrasonic receiver 310 may include a second piezoelectric layer different than the piezoelectric layer of the ultrasonic transmitter 308. For example, the piezoelectric material of the ultrasonic receiver 310 may be any suitable piezoelectric material such as, for example, a layer of PVDF or a PVDF copolymer. The piezoelectric layer of the ultrasonic receiver 310 may convert vibrations caused by the ultrasonic reflections into electrical output signals. In some implementations, the ultrasonic receiver 310 further includes a thin-film transistor (TFT) layer. In some such implementations, the TFT layer may include an array of sensor pixel circuits configured to amplify the electrical output signals generated by the piezoelectric layer of the ultrasonic receiver 310. The amplified electrical signals provided by the array of sensor pixel circuits may then be provided as raw measured image data to the processing unit for use in processing the image data, identifying a fingerprint associated with the image data, and in some applications, authenticating a user associated with the fingerprint. In some implementations, a single piezoelectric layer may serve as the ultrasonic transmitter 308 and the ultrasonic receiver 310. In some implementations, the substrate 304 may be a glass, plastic or silicon substrate upon which electronic circuitry may be fabricated. In some implementations, an array of sensor pixel circuits and associated interface circuitry of the ultrasonic receiver 310 may be configured from CMOS circuitry formed in or on the substrate 304. In some implementations, the substrate 304 may be positioned between the platen 306 and the ultrasonic transmitter 308 and/or the ultrasonic receiver 310. In some implementations, the substrate 304 may serve as the platen 306. One or more protective layers, acoustic matching layers, anti-smudge layers, adhesive layers, decorative layers, conductive layers or other coating layers (not shown) may be included on one or more sides of the substrate 304 and the platen 306.

The platen 306 may be formed of any suitable material that may be acoustically coupled with the ultrasonic transmitter 308. For example, the platen 306 may be formed of one or more of glass, plastic, ceramic, sapphire, metal or metal alloy. In some implementations, the platen 306 may be a cover plate such as, for example, a cover glass or a lens glass of an underlying display. In some implementations, the platen 306 may include one or more polymers, such as one or more types of parylene, and may be substantially thinner. In some implementations, the platen 306 may have a thickness in the range of about 10 microns (μm) to about 1000 μm or more.

FIG. 4 shows an exploded projection view of an example of components of an example ultrasonic sensing system according to another implementation. In the illustrated implementation, the ultrasonic sensing system 400 includes an ultrasonic transmitter 408. The ultrasonic transmitter 408 may include a substantially planar piezoelectric transmitter layer 422 capable of functioning as a plane wave generator. Ultrasonic waves may be generated by applying a voltage across the piezoelectric transmitter layer 422 to expand or contract the layer, depending upon the voltage signal applied, thereby generating a plane wave. In this example, the processing unit (not shown) is capable of causing a transmitter excitation voltage to be applied across the piezoelectric transmitter layer 422 via a first transmitter electrode 424 and a second transmitter electrode 426. The first and second transmitter electrodes 424 and 426 may be metallized electrodes, for example, metal layers that coat opposing sides of the piezoelectric transmitter layer 422. As a result of the piezoelectric effect, the applied transmitter excitation voltage causes changes in the thickness of the piezoelectric transmitter layer 422, and in such a fashion, generates ultrasonic waves at the frequency of the transmitter excitation voltage.

The ultrasonic waves may travel towards an object to be imaged (“target object”, not illustrated), passing through the platen 406. A portion of the ultrasonic waves not absorbed or transmitted by the target object may be reflected back through the platen 406 and received by the ultrasonic receiver 410, which, in the implementation illustrated in FIG. 4, overlies the ultrasonic transmitter 408. The ultrasonic receiver 410 may include an array of sensor pixel circuits 432 disposed on a substrate 434 and a piezoelectric receiver layer 436. In some implementations, each sensor pixel circuit 432 may include one or more TFT or CMOS transistor elements, electrical interconnect traces and, in some implementations, one or more additional circuit elements such as diodes, capacitors, and the like. Each sensor pixel circuit 432 may be configured to convert an electric charge generated in the piezoelectric receiver layer 436 proximate to the pixel circuit into an electrical signal. Each sensor pixel circuit 432 may include a pixel input electrode 438 that electrically couples the piezoelectric receiver layer 436 to the sensor pixel circuit 432.

In the illustrated implementation, a receiver bias (R_{bias}) electrode 440 is disposed on a side of the piezoelectric receiver layer 436 proximal to the platen 406. The R_{bias} electrode 440 may be a metallized electrode and may be grounded or biased to control which signals may be passed to the array of sensor pixel circuits 432. Ultrasonic energy that is reflected from the exposed (upper/top) surface 442 of the platen 306 may be converted into localized electrical charges by the piezoelectric receiver layer 436. These localized charges may be collected by the pixel input electrodes 438 and passed on to the underlying sensor pixel circuits 432. The charges may be amplified or buffered by the sensor pixel circuits 432 and provided to the processing unit. The processing unit may be electrically connected (directly or indirectly) with the first transmitter electrode 424 and the second transmitter electrode 426, as well as with the R_{bias} electrode 440 and the sensor pixel circuits 432 on the substrate 434. In some implementations, the processing unit may operate substantially as described above. For example, the processing unit may be capable of processing the signals received from the sensor pixel circuits 432.

Some examples of suitable piezoelectric materials that can be used to form the piezoelectric transmitter layer 422 or the piezoelectric receiver layer 436 include piezoelectric polymers having appropriate acoustic properties, for example, an acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be utilized include polyvinylidene chloride (PVDC) homopolymers and copolymers, polytetrafluoroethylene (PTFE) homopolymers and copolymers, and diisopropylammonium bromide (DIPAB).

In some implementations, at least elements of ultrasonic receiver 410 may be co-fabricated with sensor pixel circuits 432 configured as thin-film transistor (TFT) circuitry or CMOS circuitry on or in the same substrate, which may be a silicon, SOI, glass or plastic substrate, in some examples. For example, a TFT substrate may include row and column addressing electronics, multiplexers, local amplification stages and control circuitry.

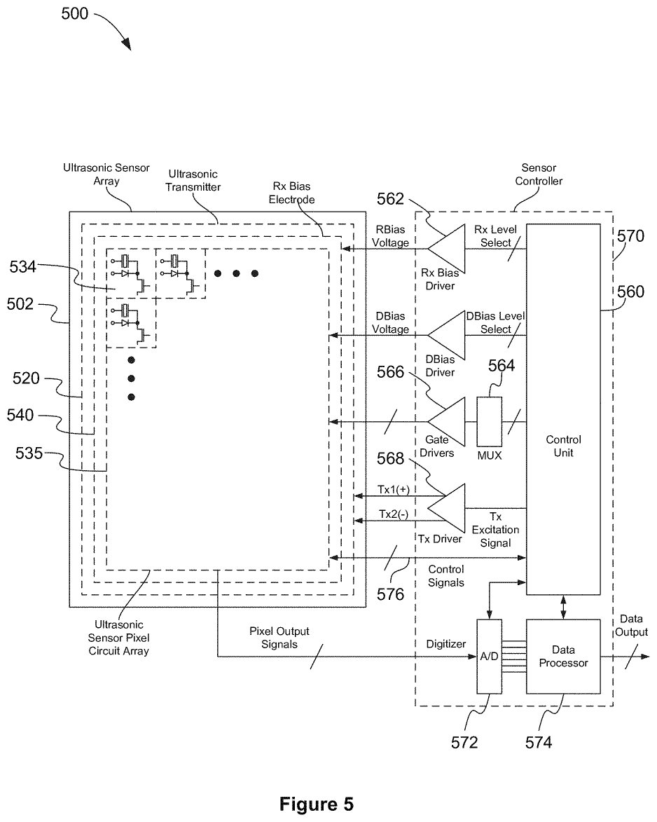

FIG. 5 illustrates a block diagram of an ultrasonic sensor system, according to an implementation. The ultrasonic sensor system 500 may include an ultrasonic sensor array 502 that includes an ultrasonic transmitter 520, an ultrasonic sensor pixel circuit array 535 and an Rx bias electrode 540. The ultrasonic transmitter 520 may be electrically coupled with a transmitter driver (“Tx driver”) 568. In some implementations, the Tx driver 568 may have a positive polarity output signal (Tx1(+)) and a negative polarity output signal (Tx2(−)) electrically coupled with one or more transmitter electrodes associated with the ultrasonic transmitter 520. The Tx driver 568 may be electrically coupled with a control unit 560 of a sensor controller 570. The control unit 560 may be configured to control various aspects of the sensor system 500, e.g., ultrasonic transmitter timing and excitation waveforms, bias voltages, pixel addressing, signal filtering and conversion, readout frame rates, and so forth. The control unit 560 may provide one or more transmitter excitation signals to the Tx driver 568. The control unit 560 may be electrically coupled with a receiver (Rx) bias driver 562 through, for example, an Rx level select input bus. The Rx bias driver 562 may provide an RBias voltage to the Rx bias electrode 540. The control unit 560 may be electrically coupled with one or more demultiplexers 564. The demultiplexers 564 may be electrically coupled with a plurality of gate drivers 566. The gate drivers 566 may be electrically coupled with the sensor pixel circuit array 535 of the ultrasonic sensor array 502. The gate drivers 566 may be positioned external to the sensor pixel circuit array 535, in some implementations. In other implementations, the gate drivers 566 may be included on a common substrate with the sensor pixel circuit array 535. The demultiplexers 564, which may be external to or included on a common substrate with the sensor pixel circuit array 535, may be used to select specific gate drivers 566. The gate drivers 566 may select one or more rows or columns of the sensor pixel circuit array 535. The sensor pixel circuit array 535, which, in the illustrated implementation, includes a number of individual ultrasonic sensor pixels 534, may be electrically coupled with one or more digitizers 572. The digitizers 572 may convert analog pixel output signals from one or more of the individual sensor pixels 534 to digital signals suitable for further processing within a data processor 574. The data processor 574 may be included (as illustrated) in the sensor controller 570. In other implementations, the data processor 574 may be external to the sensor controller 570. In the illustrated implementation, the sensor controller 570 may include one or more data processors 574 that receive data from the sensor pixel circuit array 535. The sensor controller 570 may provide data outputs to an external system or processor, such as an applications processor of a mobile device. The data processor 574 may translate the digitized data into image data of a fingerprint or format the data for further processing.

Each ultrasonic sensor pixel 534 may include a PMUT element that may serve as an ultrasonic receiver and/or an ultrasonic transmitter. Each sensor pixel 534 may also include a sensor pixel circuit that is associated with the PMUT element. The associated PMUT element may overlay each sensor pixel circuit, that is, the associated PMUT element and the sensor pixel circuit may be included within a common footprint area. Advantageously, the sensor pixel circuit may be contained in a footprint area that is no larger than a footprint area of the PMUT element. In some implementations, the ultrasonic transmitter 520 may include a layer of piezoelectric material sandwiched between two transmitter electrodes and positioned above or below the ultrasonic sensor pixel circuit array 535.

The ultrasonic transmitter 520 may be electrically coupled to and driven by the transmitter excitation signals by way of the Tx driver 568 to generate and launch ultrasonic waves. In some implementations, the transmitter excitation signals may be coupled to one or more electrodes in each PMUT or PMUT array, such as a transmit electrode associated with each PMUT, to allow the generation and launching of ultrasonic waves. In some implementations, the PMUTs in the PMUT array may be provided with a transmitter excitation signal that may be applied in common to some or all of the transmit electrodes in the PMUT array to launch a substantially plane ultrasonic wave.

In some implementations, the control unit 560 may be configured to send a Tx excitation signal to a Tx driver 568 at regular intervals so as to cause the Tx driver 568 to excite the ultrasonic transmitter 520 and produce one or more ultrasonic waves. The control unit 560 may also be configured to send level select input signals through the Rx bias driver 562 to bias the Rx bias electrode 539 and allow gating for ultrasonic signal detection by the ultrasonic sensor pixels 534. One or more of the demultiplexers 564 may be used to turn on and off the gate drivers 566 that cause a particular row or column of the sensor pixel circuit array 535 to provide pixel output signals. Output signals from the sensor pixel circuit array 535 may be sent through a charge amplifier, a filter such as a resistor-capacitor (RC) filter or an anti-aliasing filter, and the digitizer 572 to the data processor 574. One or more control lines 576 may carry control signals between the sensor controller 570 and the ultrasonic sensor array 502.

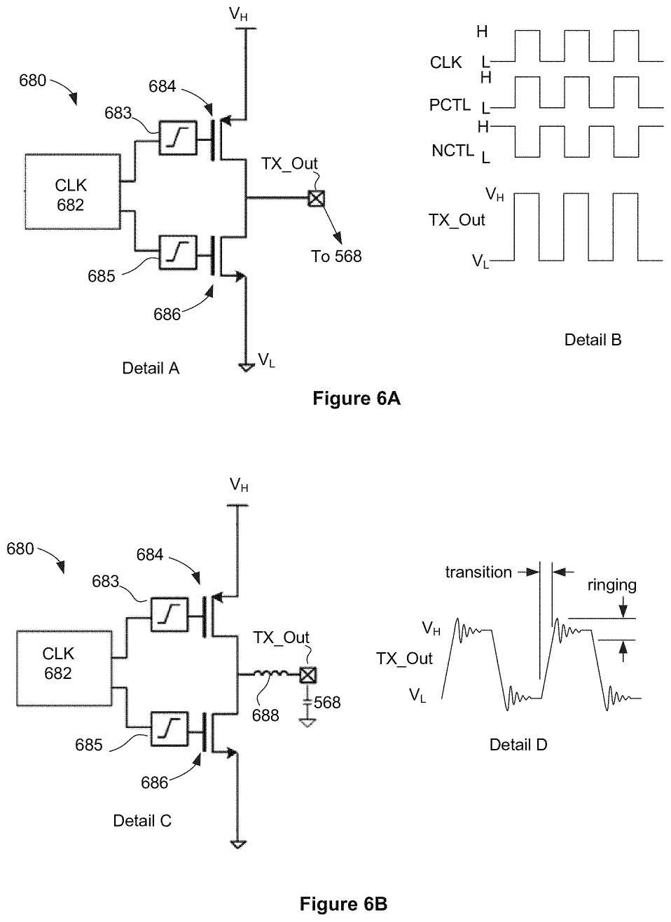

The Tx driver 568 may be coupled with a DC voltage supply by way of a switching arrangement. FIGS. 6A and 6B illustrate aspects of a bi-level switching arrangement for controlling a voltage waveform provided to a Tx driver. Referring first to FIG. 6A, Detail A illustrates a simplified, idealized schematic in which a switching arrangement 680 includes a clock (CLK) 682, level shifters 683 and 685, and transistors 684 and 686. The CLK 682 may be or include a non-overlapping clock signal generator circuit. The transistor 684 (in the illustrated example, a pMOSFET (p-channel Metal Oxide Semiconductor Field Effect Transistor), includes a source terminal coupled with the DC voltage V_{H} and a drain terminal coupled with a drain terminal of the transistor 686 (in the illustrated example, an n-channel MOSFET (“nMOSFET”) and with a node TX_Out that is coupled with Tx driver 568. A source terminal of the transistor 686 is coupled with ground (V_{L}).

The CLK signal generator 682 is configured to output a periodic signal waveform, as indicated by the “CLK” waveform illustrated in Detail B. When the CLK signal is high (H), a first control pulse PCTL output by level shifter 683 (PCTL waveform illustrated in Detail B) is high, and a second control pulse NCTL output by level shifter 685 (NCTL waveform illustrated in Detail B) is low. When PCTL is high and NCTL is low, the pMOSFET is actuated on and the nMOSFET is actuated off, thereby coupling TX_Out with V_{H} and isolating TX_Out from V_{L}. When PCTL is low and NCTL is high, the pMOSFET is actuated off and the nMOSFET is actuated on, thereby isolating TX_Out from V_{H} and coupling TX_Out with V_{L}. A resulting waveform of the voltage at node TX_Out (TX_Out waveform illustrated in Detail B) is, for the simplified, idealized example illustrated in FIG. 6A, approximately a square wave.

FIG. 6B illustrates a more detailed representation of the circuit described above in connection with FIG. 6A. As illustrated in Detail C, the TX_Out terminal is coupled with the switching arrangement 680 by bonding wires 688 that may be expected to exhibit a parasitic inductance. Moreover, the Tx driver 568 is represented as a capacitive load between the TX_Out terminal and ground. As illustrated in Detail D, a more precisely modeled TX_Out waveform includes a finite “transition” time between high and low conditions and “ringing” due to the parasitic inductance of bonding wires 688 and the capacitance of the Tx driver 568.

For certain applications, including ultrasonic sensing, a tri-level signal switching arrangement is desirable in which a selectable third voltage, intermediate between V_{L} and V_{H}, is obtained. Preferably, the third voltage may be obtained while avoiding a need to modify a DC power supply voltage supply that delivers V_{H}.

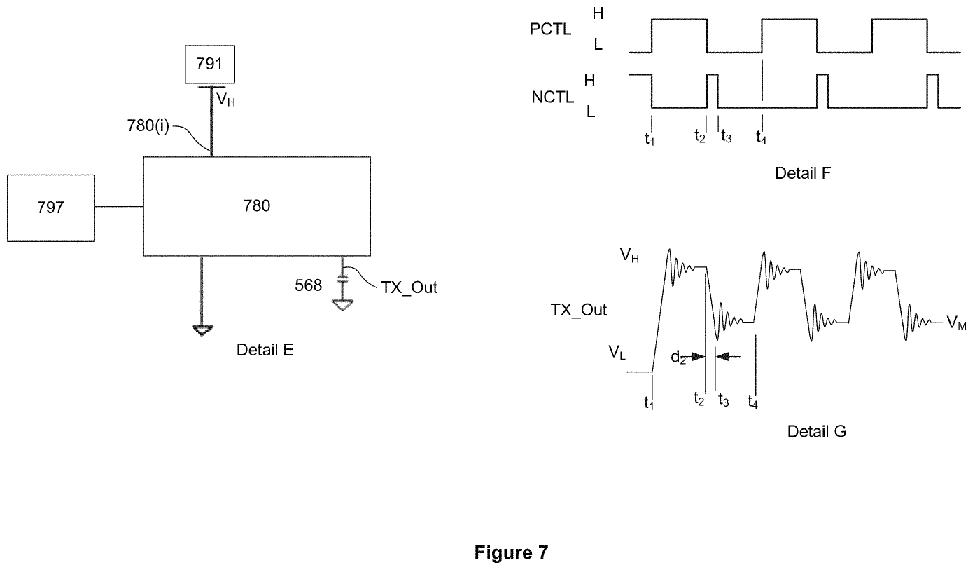

FIG. 7 illustrates a technique for controlling a voltage waveform, so as to obtain a tri-level voltage output, according to an implementation. Referring first to Detail E, the illustrated implementation includes a voltage supply 791 having a single output voltage, V_{H}, and a switching arrangement 780. The switching arrangement 780 may be similar or identical to the switching arrangement 680 described in connection with FIGS. 6A and 6B. The switching arrangement 780 includes an input, 780(i) and a voltage transmitter output, Tx_Out. The input 780(i) is coupled with output voltage V_{H} of the voltage supply 791. The illustrated implementation includes a controller 797 coupled with the switching arrangement 780 and configured to operate the switching arrangement 780 so as to provide, at the Tx_Out, a voltage that varies between an intermediate voltage, V_{M} and one or both of V_{H}, and a minimum voltage, V_{L}.

V_{M} may be obtained by judiciously timing the actuation of switches included in the switching arrangement 780. For example, in implementations where switching arrangement 780 is similar or identical to the switching arrangement 680, the controller 797 may be configured to actuate transistors 684 and 685 according to the PCTL and NCTL wave form diagrams illustrated in Detail F. More specifically, during a first interval between time t₁ and t₂, when PCTL is high and NCTL is low, the pMOSFET is actuated on and the nMOSFET is actuated off, thereby coupling TX_Out with V_{H} and isolating TX_Out from V_{L}. During a second interval between time t₂ and time t₃, PCTL is low and NCTL is high, the pMOSFET is actuated off and the nMOSFET is actuated on, thereby isolating TX_Out from V_{H} and coupling TX_Out with V_{L}. During a third interval between time t₃ and time t₄, PCTL is low and NCTL is low, the pMOSFET is actuated off and the nMOSFET is actuated off, thereby isolating TX_Out from both V_{H} and V_{L}.

Referring now to Detail G, during the second interval between time t₂ and time t₃, TX_Out may partially discharge to ground. As a result, the voltage at TX_Out will decline from V_{H} toward an intermediate voltage V_{M}. During the third interval between time t₃ and time t₄, the voltage at TX_Out undergoes transient ringing that results from parasitic capacitances and inductances, before reaching the steady state value of V_{M}. It will be appreciated that a generally inverse relationship will exist between the duration, d₂, of the second interval between time t₂ and time t₃ and the value of V_{M}. That is, increasing the duration of d2, will reduce the value of V_{M}, whereas decreasing the duration of d₂, will increase the value of V_{M}.

In some applications, it may be desirable to provide for a selectable value of V_{M} that can be obtained repeatably and with good accuracy. In the absence of the presently disclosed techniques, even for an accurately controlled duration d₂, there will be considerable uncertainty and variability in the value of V_{M} as a result of unavoidable uncertainties in the characteristics of the parasitic capacitances and inductances that may result from, for example, unit-to-unit, temporal and environmental variations. To mitigate this problem, in some implementations, a successive approximation calibration technique is contemplated that includes making a comparison between a reference voltage and a value of the TX_Out voltage at the end of each of a succession of voltage bursts. Based on the comparison, the value of d₂ may be adjusted, and a subsequent burst may be executed and another comparison made between the reference voltage and the value of the TX_Out voltage at the end of the subsequent voltage burst. The process may be repeated any number of times. As a result, the voltage at the end of burst may be caused to converge to the reference voltage so that a three level burst with a desired V_{M} is obtained after calibration.

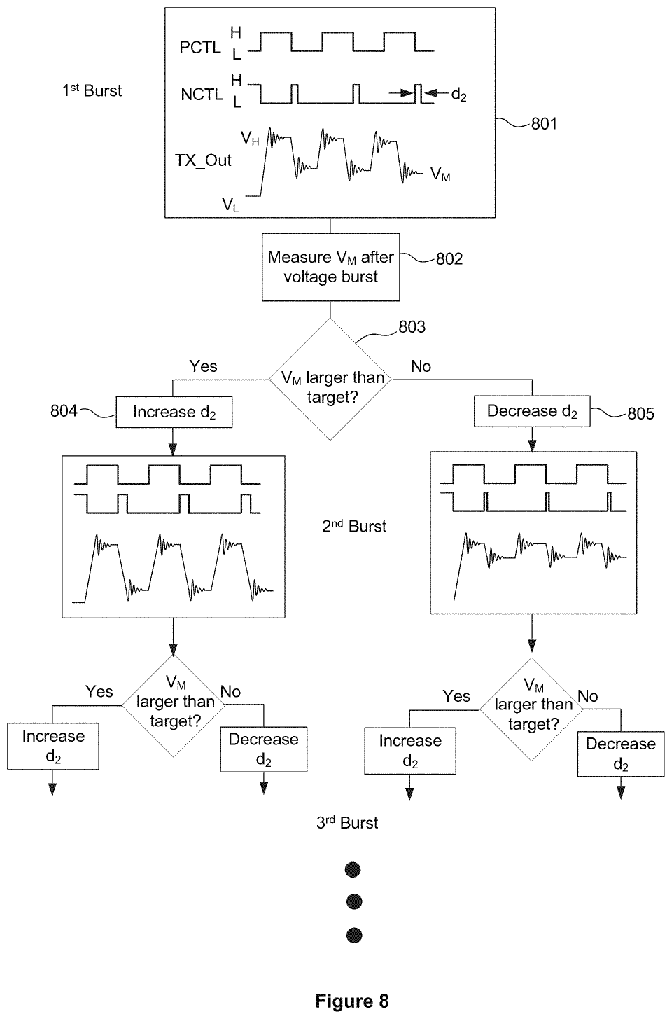

FIG. 8 illustrates a process for obtaining a desired V_{M} using successive approximation calibration, according to an implementation. In the illustrated implementation, the duration d₂ is controllable, at least between voltage bursts. In some implementations, the duration d₂ may be programmable with a binary weighted delay line.

At block 801, a calibration cycle is started by sending a first voltage burst. At the end of the burst, an obtained value of V_{M} is measured, block 802, and compared, block 803, to a target value. If the measured V_{M} is larger than the target, the duration d₂ is increased, block 804. If the measured V_{M} voltage is not larger than the target, the duration d₂ is decreased, block 805.

After multiple bursts, (e.g., 5-10) the voltage at the end of burst can be expected to converge sufficiently close to the target. Advantageously, the presently disclosed calibration method accounts for the impact of parasitic inductance/capacitance and measures the voltage after the burst, that is, after ringing has settled.

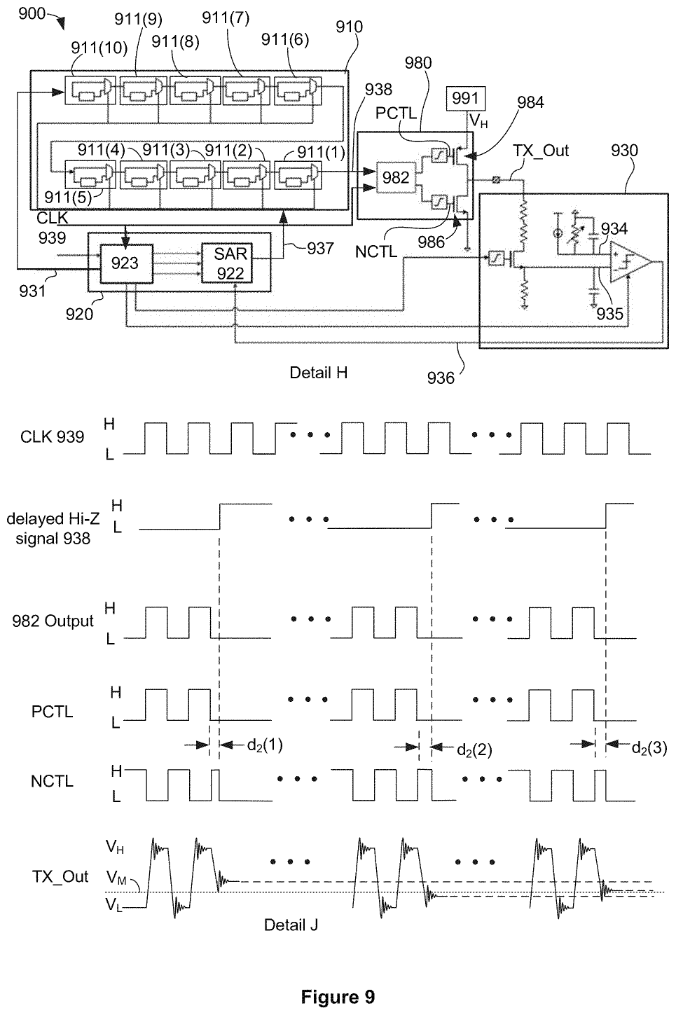

FIG. 9 illustrates a technique for controlling a voltage waveform, so as to obtain a tri-level voltage output, according to another implementation. Referring first to Detail H, in the illustrated implementation, a system 900 includes voltage supply 991 having a single output voltage, V_{H}, and a switching arrangement 980. A control arrangement coupled with the switching arrangement 980 includes a bit-wise delay line register 910, a successive approximation module 920 and a comparator circuit 930. In the illustrated implementation, the bit-wise delay line register 910 includes a plurality of delay units 911, and the successive approximation module 920 includes a successive approximation register (SAR) 922 and a SAR controller 923.

In the illustrated implementation, the system 900 may operate in the following manner. The comparator circuit 930 outputs to the SAR 922 a comparison result signal 936 representative of a difference between inputs 934 and 935, where input 934 relates to an adjustable reference voltage value (“target voltage”) of intermediate voltage V_{M}, and input 935 relates to an actual voltage at TX_Out. SAR 922 may successively receive the comparison result signal 936 and output successive control signals 937 to the register 910, each successive control signal 937 configured to enable or disable (bypass) a respective one of a plurality of delay units 911 disposed in series with Hi-Z signal 931. A resulting successive signal 938 (that may be referred to as “delayed Hi-Z” signal 938) is input to block 982 (that may be referred to as a non-overlap with Hi-Z control block 982) which also receives a clock signal 939. Example waveforms of the clock signal 939 (CLK 939) and delayed Hi-Z signal 938 are illustrated Detail J. The non-overlap with Hi-Z control block 982 may be configured to output a signal waveform, as indicated by the “982 Output” waveform illustrated in Detail J. When the delayed Hi-Z signal 938 is low (L), the 982 output is high (H); when the CLK 939 is high and low when the CLK 939 is low. When the Hi-Z signal 938 is high, the 982 Output is low irrespective of whether the CLK 939 is high or low. When the 982 output signal is high (H), a first control pulse PCTL output to pMOSFET 984 is high, and a second control pulse NCTL output to nMOSFET 986 is low. When PCTL is high and NCTL is low, the pMOSFET 984 is actuated on and the nMOSFET 986 is actuated off, thereby coupling TX_Out with V_{H} and isolating TX_Out from V_{L}. When PCTL is low and NCTL is high, the pMOSFET 984 is actuated off and the nMOSFET 986 is actuated on, thereby isolating TX_Out from V_{H} and coupling TX_Out with V_{L}. A resulting waveform of the voltage at node TX_Out is illustrated in Detail J.

During a succession of cycles, TX_Out may be compared by the comparator circuit 930 with target voltage V_{M}, and output the comparison result signal 936 to SAR 922, which is configured to enable or disable a respective delay unit 911(i).

In an implementation, the duration of d₂ is programmable with a weighted delay line. A calibration cycle may be started with a first voltage burst. At the end of the first voltage burst, the TX_out voltage is measured and compared to V_{M}. If TX_out voltage is larger than V_{M}, it may be determined that d₂ is too short. As a result, SAR 922 may enable the next delay unit 911(i) to increase the duration of d₂ in order to reduce the value of TX_out.

If a successive voltage burst results in a TX_out voltage that is smaller than V_{M}, it may be determined that d₂ is too long. As a result, SAR 922 may disable the next delay unit 911(i) to decrease the duration of d₂ in order to increase the value of TX_out. Thus, after multiple successive approximation cycles, the voltage at the end of burst converges to the target voltage V_{M}.

Advantageously, the TX_out voltage is measured after the burst, that is, only after the ringing settles, taking into consideration parasitic inductances and capacitances.

In the implementation illustrated in FIG. 9, ten delay units 911 are contemplated. Advantageously, an approximately binary weighting between adjacent units may be contemplated. For example, the weightings of delay units 911(1) through 911(10) may be as follows: 911(1): 1; 911(2): 1; 911(3): 2; 911(4):2: 2; 911(5): 4; 911(6): 4; 911(7): 8; 911(8): 16; 911(9): 32; 911(10): 32.

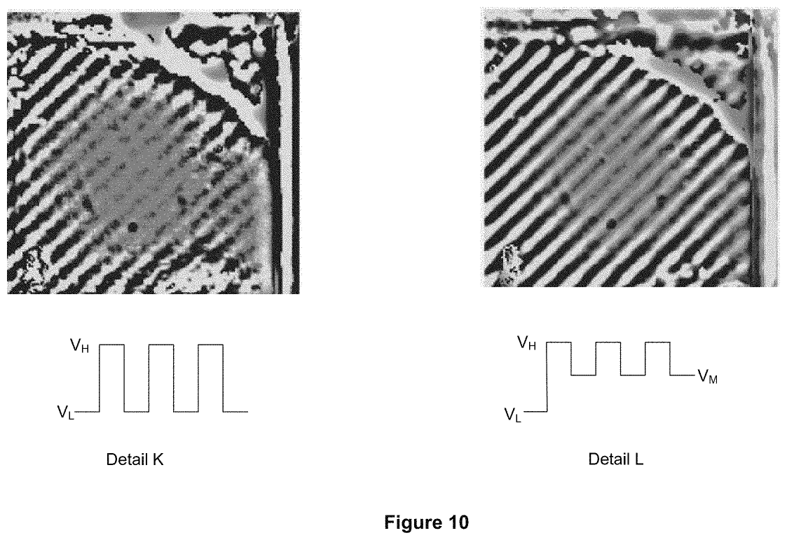

The presently disclosed techniques may advantageously be employed so as generate a three-level voltage burst for ultrasonic imaging applications such as fingerprint imaging. In such applications, for example, V_{H} may have a value of some tens of volts and V_{M} may be approximately ½ of V_{H}. In some applications, V_{H} may be in the range of 20-40 volts and V_{M} is in the range of 8-22 volts, for example. FIG. 10 illustrates a simulated finger print image obtained by an ultrasonic sensor using a bi-level voltage output compared with an image obtained by an ultrasonic sensor using a tri-level voltage output. Detail K illustrates a bi-level waveform and resulting obtained ultrasonic image. Detail L illustrates a tri-level waveform and resulting obtained ultrasonic image. It may be observed that the image of Detail L has less distortion.

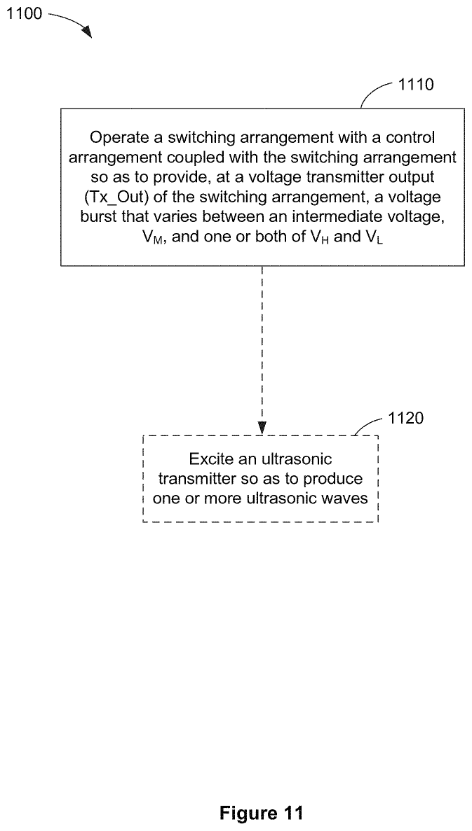

FIG. 11 illustrates an example of a process flow for generating a voltage burst, according to an implementation. As described hereinabove, the voltage burst may be generated with a voltage supply having a single DC output voltage, V_{H}, and a control arrangement coupled with a switching arrangement, the switching arrangement including an input and a voltage transmitter output (Tx_Out), the input coupled with the output of the voltage supply. The method 1100 includes a block 1110 of operating the switching arrangement with the control arrangement so as to provide, at Tx_Out of the switching arrangement, a voltage burst that varies between an intermediate voltage, V_{M}, and one or both of V_{H}, and a minimum voltage, V_{L}, where V_{L}<V_{M}<V_{H}.

Optionally, Tx_Out may be electrically coupled with a Tx driver of an ultrasonic transducer and the method 1100 may include exciting, at block 1120, an ultrasonic transmitter so as to produce one or more ultrasonic waves.

Thus, techniques for generating a three-level voltage burst suitable for ultrasonic imaging applications has been disclosed. It will be appreciated that a number of alternative configurations and operating techniques may be contemplated.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by or to control the operation of data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus for generating a voltage burst, comprising:
a voltage supply having a single DC output voltage, V_{H};
a switching arrangement, including an input and a voltage transmitter output (Tx_Out), the input coupled with the output of the voltage supply; and
a control arrangement coupled with the switching arrangement and configured to operate the switching arrangement so as to provide, at the Tx_Out, a voltage burst that varies between an intermediate voltage, V_{M}, and one or both of V_{H}, and a minimum voltage, V_{L}, wherein
V_{L}<V_{M}<V_{H}.

2. The apparatus of claim 1, wherein V_{L} is zero.

3. The apparatus of claim 1, wherein V_{M} is an average of V_{L} and V_{H}.

4. The apparatus of claim 1, wherein the switching arrangement includes a pMOSFET and an nMOSFET, coupled with a clock.

5. The apparatus of claim 4, wherein:
the input of the switching arrangement is electrically coupled with a source terminal of the pMOSFET;
a source terminal of the nMOSFET is coupled with ground; and
the Tx_Out is coupled, by way of a respective drain terminal, with each of the pMOSFET and the nMOSFET.

6. The apparatus of claim 1, wherein the control arrangement includes a bit-wise delay line register, a successive approximation module and a comparator circuit.

7. The apparatus of claim 1, wherein the Tx_Out is electrically coupled with a Tx driver configured to excite an ultrasonic transmitter and produce one or more ultrasonic waves.

8. The apparatus of claim 7 wherein the control arrangement is configured to:
execute a plurality of successive approximation cycles; and
after each of the successive cycles, make a comparison between a measured voltage value at the Tx_Out and a target value of the intermediate voltage V_{M}.

9. The apparatus of claim 8, wherein:
the bit-wise delay line register includes a plurality of delay units; and
based on the comparison after each of the successive cycles, a respective one of the plurality of delay units is enabled or disabled by the control arrangement.

10. The apparatus of claim 8, wherein V_{M} is adjustable, by the control arrangement, within a range between V_{L} and V_{H}.

11. The apparatus of claim 10 wherein V_{H} is in the range of 20-40 volts and V_{M} is in the range of 8-22 volts.

12. A method for generating a voltage burst, comprising:
operating a switching arrangement with a control arrangement coupled with the switching arrangement so as to provide, at a voltage transmitter output (Tx_Out) of the switching arrangement, a voltage burst that varies between an intermediate voltage, V_{M}, and one or both of V_{H}, and a minimum voltage, V_{L}, wherein:
the switching arrangement includes an input coupled to an output of a voltage supply having a single DC output voltage, V_{H}; and
V_{L}<V_{M}<V_{H}.

13. The method of claim 12, wherein V_{L} is zero.

14. The method of claim 12, wherein V_{M} is an average of V_{L} and V_{H}.

15. The method of claim 12, wherein the switching arrangement includes a pMOSFET and an nMOSFET, coupled with a clock.

16. The method of claim 12, wherein the control arrangement includes a bit-wise delay line register, a successive approximation module and a comparator circuit.

17. The method of claim 16 wherein operating the switching arrangement includes:
executing a plurality of successive approximation cycles; and
after each of the successive cycles, making a comparison between measured voltage value at the Tx_Out and a target value of the intermediate voltage V_{M}.

18. The method of claim 17, wherein:
the bit-wise delay line register includes a plurality of delay units; and
operating the switching arrangement includes enabling or disabling a respective one of the plurality of delay units with the control arrangement based on the comparison after each of the successive cycles.

19. The method of claim 18, wherein V_{M} is adjustable, by the control arrangement, within a range between V_{L} and V_{H}.

20. The method of claim 12, wherein the Tx_Out is electrically coupled with a Tx driver of an ultrasonic transducer and further comprising exciting an ultrasonic transmitter and produce one or more ultrasonic waves.

21. A non-transitory computer readable medium having software stored thereon, the software including instructions for causing an apparatus to generate a voltage burst, the instructions including:
operating a switching arrangement with a control arrangement coupled with the switching arrangement so as to provide, at a voltage transmitter output (Tx_Out) of the switching arrangement, a voltage burst that varies between an intermediate voltage, V_{M}, and one or both of V_{H}, and a minimum voltage, V_{L}, wherein:
the switching arrangement, includes an input coupled to an output of a voltage supply having a single DC output voltage, V_{H}; and
V_{L}<V_{M}<V_{H}.

22. The computer readable medium of claim 21, wherein the control arrangement includes a bit-wise delay line register, a successive approximation module and a comparator circuit.

23. The computer readable medium of claim 22 wherein operating the switching arrangement includes:
executing a plurality of successive approximation cycles; and
after each of the successive cycles, making a comparison between measured voltage value at the Tx_Out and a target value of the intermediate voltage V_{M}.

24. The computer readable medium of claim 23, wherein:
the bit-wise delay line register includes a plurality of delay units; and
operating the switching arrangement includes enabling or disabling a respective one of the plurality of delay units with the control arrangement based on the comparison after each of the successive cycles.

25. The computer readable medium of claim 21, wherein the Tx_Out is electrically coupled with a Tx driver of an ultrasonic transducer and further comprising exciting an ultrasonic transmitter and produce one or more ultrasonic waves.

26. An apparatus for generating a voltage burst, comprising:
an ultrasonic transducer;
a voltage supply having a single DC output voltage, V_{H};
a switching arrangement, including an input and a voltage transmitter output (Tx_Out), Tx_Out being electrically coupled with a Tx driver configured to excite the ultrasonic transmitter, the input being coupled the output of the voltage supply; and
a control arrangement coupled with the switching arrangement and configured to operate the switching arrangement so as to provide, at the Tx_Out, a voltage burst that varies between an intermediate voltage, V_{M}, and one or both of V_{H}, and a minimum voltage, V_{L}, wherein
V_{L}<V_{M}<V_{H}.

27. The apparatus of claim 26, wherein:
the switching arrangement includes a pMOSFET and an nMOSFET, coupled with a clock;
the input of the switching arrangement is electrically coupled with a source terminal of the pMOSFET;
a source terminal of the nMOSFET is coupled with ground; and
the Tx_Out is coupled, by way of a respective drain terminal, with each of the pMOSFET and the nMOSFET.

28. The apparatus of claim 26, wherein the control arrangement includes a bit-wise delay line register, a successive approximation module and a comparator circuit.

29. The apparatus of claim 28, wherein the control arrangement is configured to:
execute a plurality of successive approximation cycles; and
after each of the successive cycles, make a comparison between a measured voltage value at the Tx_Out and a target value of the intermediate voltage V_{M}.

30. The apparatus of claim 29, wherein:
the bit-wise delay line register includes a plurality of delay units; and
based on the comparison after each of the successive cycles, a respective one of the plurality of delay units is enabled or disabled by the control arrangement.
